(19) United States
(12) Patent Application Publication
(10) Pub. No.: US 2022/0253767 A1
(43) Pub. Date: Aug. 11, 2022

(54) COMPUTERIZED SYSTEM AND METHOD FOR DYNAMIC TASK MANAGEMENT AND EXECUTION

(71) Applicant: VERIZON PATENT AND LICENSING INC., Basking Ridge, NJ (US)

(72) Inventors: Priyansh NIGAM, Alpharetta, GA (US); Chouting ZHANG, Alpharetta, GA (US); Pavani GULLAPALLI, Cumming, GA (US); Amy E. HOOPER, Christchurch (NZ); Douglas COIMBRA DE ANDRADE, Florence (IT)

(73) Assignee: VERIZON PATENT AND LICENSING INC., Basking Ridge, NJ (US)

(21) Appl. No.: 17/170,950

(22) Filed: Feb. 9, 2021

(51) Int. Cl. G06Q 10/06; G06T 7/70; G06T 7/00

(52) U.S. Cl. CPC G06Q 10/06312; G06Q 10/063114; G06T 2207/30164; G06T 7/70; G06T 7/0008; G06Q 10/06313

(57) ABSTRACT

Disclosed are systems and methods for improving interactions with and between computers in content providing, streaming and/or hosting systems supported by or configured with devices, servers and/or platforms. The disclosed systems and methods provide a novel framework that automatically and dynamically determines and prioritizes, and updates tasks at a scale incapable of being performed without machine learning or modern technology. The framework provides systems and methods for the management of a work flow whereby tasks, subtasks and the behavior and interactions of entities performing those operations are monitored to determine which tasks are in progress, which are completed, which are safe and which are to be rescheduled.

### BACKGROUND INFORMATION

Companies and businesses (collectively “entities”) acquire, manage and generate large amounts of information for decision making, planning and the operation of tasks. These entities must generate a task workflow that balances operators' or technicians' skills, location, current operating status, and the like, against the same for other operators or technicians in order to efficiently manage a jobsite.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of a network architecture for executing the task management framework discussed herein according to some embodiments of the present disclosure;

FIG. 2 is a block diagram of illustrating components of an exemplary system according to some embodiments of the present disclosure;

FIG. 3 illustrates an exemplary data flow for performing dynamic, real-time task management according to some embodiments of the present disclosure;

FIG. 4 illustrates an exemplary data flow for monitoring tasks in connection with the data flow of FIG. 3 according to some embodiments of the present disclosure;

FIGS. 5A-5K illustrate non-limiting example embodiments of the disclosed task management according to some embodiments of the present disclosure; and

FIG. 6 is a block diagram illustrating a computing device showing an example of a client or server device used in various embodiments of the present disclosure.

### DETAILED DESCRIPTION OF EXAMPLE EMBODIMENTS

Proper management of a sequence of tasks is a primary concern during construction, maintenance and inspection activities. While some tasks can be done in parallel and do not involve cross-dependencies, many cannot, as the sheer size and intricacies of a job site (e.g., a large industrial facility), as well as safety and regulation guidelines, among other perceived or unknown dangers or precautions or restrictions, prevent certain operations from being performed while others are being scheduled or performed, whether they are in close proximity or not.

For example, if the power grid is being worked on, a maintenance task that relies on power to perform the task cannot be performed. In another example, if a technician is operating a drill at a specific location on a jobsite, a plumber, at least for safety reasons, should not be fixing the sewage line in that area. In another example, it would not be safe for a welding operation to be conducted when a gas valve nearby is under maintenance. Further, there may be some tasks that can be completed in parallel, while others are sequential, and are dependent on previous tasks and have subtasks within them, therefore sequential completion is crucial to task execution. Additionally, performance of the actual task and attention of those engaged in completion of the tasks contribute to the safety measures surrounding the entire maintenance task.

Thus, due to the complexities of multiple separate tasks that are associated with most operations, the tasks, their sub-tasks and related tasks need to be contextualized and prioritized prior to their execution. The sequencing of these tasks additionally need to be updated continuously when completed so that the operation of the tasks can continue in the most efficient, safe and resource-friendly manner. The attention of a worker and performance of each task needs to be monitored for accuracy, precision and the like.

To solve the aforementioned and other problems, the disclosed systems and methods provide a novel task management framework that automatically and dynamically determines and prioritizes, and updates tasks at a scale incapable of being performed without machine learning or modern technology. Rather than a supervisor or manager doling out assignments, the disclosed systems and methods assign tasks to technicians in a real-time manner based on computerized analysis of digital information collected and analyzed from across a jobsite. The sheer volume of information required for such computations renders such task management incapable of being performed by a person using their mind or pencil and paper, or a combination of both.

The disclosed framework provides systems and methods for the management of a work flow whereby tasks, subtasks and the behavior and interactions of technicians performing those operations are monitored to determine which tasks are in progress, which are completed and the accuracy and precision of the completion, which are safe and which are to be rescheduled.

According to some embodiments, the disclosed framework provides for optimal task planning and sequencing that identifies task completion via an object-person interaction determined, inferred, derived or otherwise identified from data collected from cameras or other sensors. For example, rather than just monitoring where a technician is in relation to an asset/tool/task at a jobsite, the disclosed framework can leverage the cameras situated at or positioned within jobsites to monitor specific actions (e.g., which specific tasks or subtasks the technician is performing). For example, the cameras can be, but are not limited to, mounted cameras situated at locations within a jobsite, drones equipped with camera functionality hovering over a jobsite or location within the jobsite, mobile devices, security cameras, and the like, or some combination thereof. The cameras at a jobsite can capture a set of images of an entity, such as for example a technician, as the technician is performing a task/subtask, and based on analysis of these images via an applied objection-detection/tracking algorithm, it can be determined if the technician is turning a lever in the correct direction, pushing the correct buttons, operating the correct valve, welding the proper joint, and the like. This can assist in ensuring that the task and its subtasks are actually and properly being completed before moving on to another task or subtask, or permitting another task or subtask to be performed by another technician nearby.

As used herein, an entity may be a person (e.g., a worker or technician), an application executing on a device over interacting with an asset over a network, a robot or mechanically augmented person. References to an entity and/or worker and/or technician are used interchangeably in this disclosure.

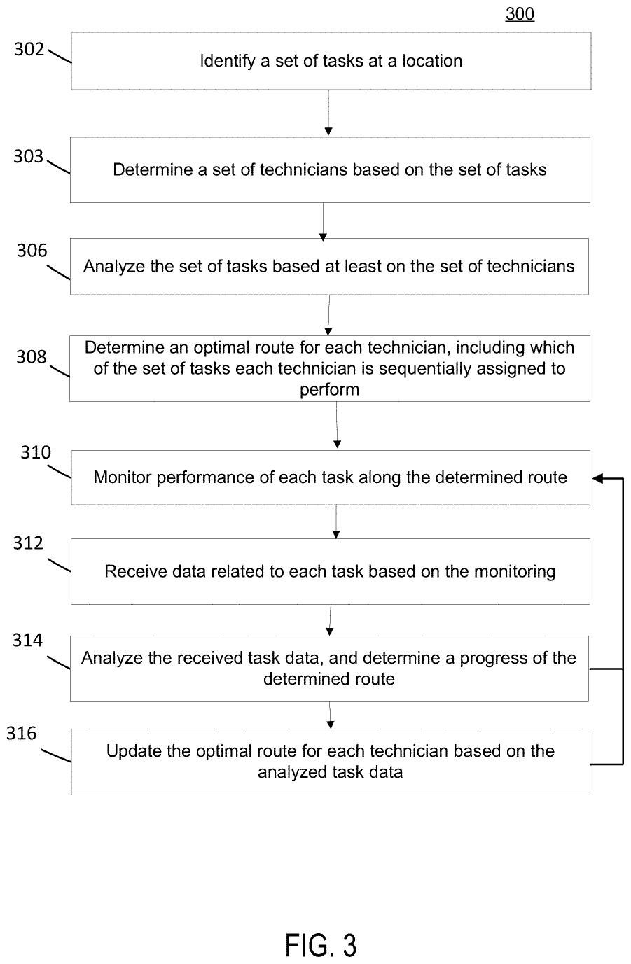

In another non-limiting embodiment, attention mapping techniques, for example, facial recognition analysis techniques, can be utilized as a basis for determining whether tasks and/or their associated subtasks have been completed properly, as discussed in detail below in relation to FIGS. 3-5K. For example, when a task is known to be complex and/or require special attention to particular components of an asset, a camera's captured imagery can be analyzed via a facial recognition algorithm to perform eye tracking to monitor where the worker's attention is being directed. For example, when an electrician is working on a fuse box, it is critical that the electrician interact with only particular circuits or fuses, and performing attention mapping on the captured images of the electrician's actions can provide confirmation that the task/subtasks are being performed correctly.

In some embodiments, a computerized method is disclosed that identifies a set of tasks, where each task corresponds to an action or actions to be performed on an asset by an entity (e.g., a technician) at a location, and each task includes a definition identifying a set of subtasks (e.g., actions). Each task is analyzed, and based on the analysis, a quantity and type of technician required to perform each action(s) for each task is determined. Based on the identified tasks and the determined technicians, an optimal route is then determined for each technician. The optimal route can be created and stored as a data structure in an associated database of the computing device performing the method, and/or can be stored in a network accessible database. The optimal route includes information assigning each technician a subset of the set of tasks and a sequence each task in the subset is to be performed.

For example, a jobsite includes 7 tasks, which include four plumbing tasks and three welding tasks. Based on analysis of this, two technicians are determined to be needed—one welder and one plumber. The plumber is assigned as subset of the assigned tasks: the four plumbing tasks; and the welder is also assigned a subset of the tasks: the three welding task. The optimal route determined for each technician comprises information indicating when (time-based) and where, or to which asset within the jobsite (geographic-based) each technician should go, and which subtasks (e.g., operations) they each need to perform for a task to be completed before they can move on to their next assigned task.

The technicians' work is monitored, in that information related to a status of a portion of tasks within the sequence is received over a network from at least one device at the location. The status corresponds to completion of subtasks of each task in the portion by each assigned technician along the determined route. According to some embodiments, the status indicates, but is not limited to, a precision in performance of the work to completion, how much progress of a task/subtask has been performed, an efficiency in the manner the work was performed (e.g., was it performed “on-time”), whether it performed by the assigned worker, whether the worker was attentive when performing the work, whether proper safety measures were taken, did the worker properly operate the equipment according to industry standards while complying with proper safety guidelines, and the like, or some combination thereof. This status information is analyzed and a progress along the optimal route is determined. When the determined progress is time-aligned to the determined optimal route, the optimal route is maintained and each subsequent task in the sequence is continually monitored for updated status information. When the determined progress corresponds to a different time parameter (e.g., schedule) than the determined optimal route, the optimal route is modified (e.g., the data structure is modified with updated information). Such modification, therefore, results in the optimal route being updated based on the received status information and electronically communicated to a device of each technician.

In some embodiments, the updated route includes a new or modified sequence of the tasks.

In some embodiments, the updated route includes a different set of assigned tasks for at least a portion of the technicians.

In some embodiments, reception and analysis of the status information step is recursively performed until each of the set of tasks are completed, wherein a task is determined to be completed when each of its subtasks are completed.

In some embodiments, the status information for a task is communicated over the network upon detection that a subtask has been completed.

In some embodiments, the task definition for each task in the subset is updated based on the received status information.

In some embodiments, the at least one device is a camera, and each camera is positioned proximate to at least a portion of assets at the location.

In some embodiments, the method further involves receiving, over the network from the at least one camera, a set of digital images related to performance of a subtask of a task in the subset, and analyzing the set of digital images, such that a status of the subtask is determined, where the received status information corresponds to the determined status.

In some embodiments, the analysis involves execution of an attention mapping algorithm on input defined by the set of digital images, where the determined status is based on a determination of which component of an asset a technician is interacting with. In some embodiments, the analysis involves execution of an object detection algorithm on input defined by the set of digital images, wherein the determined status is based on at least a detected pose or gesture of a technician.

In some embodiments, the method further involves determining, based on the analysis of the received status information, that an alarm needs to be communicated to at least one technician at the location, where the alarm indicates a safety issue that provides a corresponding instruction to the at least one technician.

In some embodiments, the determination of the optimal route is based on execution of an auto-regressive model with an input comprising at least the task definitions.

In some embodiments, the quantity of technicians corresponds to a number of a type of technicians that are required to perform each subtask. In some embodiments, the type of technicians corresponds to a qualification a technician has to perform each task.

In some embodiments, the location comprises a plurality of assets, wherein each asset is equipment or machinery.

In some embodiments, a device is disclosed comprising a processor that is configured to execute computer-executable instructions or program logic that identifies a set of tasks, where each task corresponds to an action to be performed on an asset by a technician at a location, and each task includes a definition identifying a set of subtasks. Each task is analyzed, and based on the analysis, a quantity and type of technician required for each task is determined. An optimal route is also determined for each technician, where the optimal route includes information assigning each technician a subset of the set of tasks and a sequence each task in the subset is to be performed. The technicians' work is monitored, in that information related to a status of a portion of tasks within the sequence is received over a network from at least one device at the location, where the status corresponds to completion of subtasks of each task in the portion by each assigned technician along the determined route. This status information is analyzed and a progress along the optimal route is determined. When the determined progress is time-aligned to the determined optimal route, the optimal route is maintained and each subsequent task in the sequence is continually monitored for updated status information. When the determined progress corresponds to a different time schedule than the determined optimal route, the optimal route is updated based on the received status information and communicated to each technician.

In some embodiments, a non-transitory computer-readable storage medium for storing instructions capable of being executed by a processor is disclosed. In these embodiments, the medium, upon execution of these instructions identifies a set of tasks, where each task corresponds to an action to be performed on an asset by a technician at a location, and each task includes a definition identifying a set of subtasks. Each task is analyzed, and based on the analysis, a quantity and type of technician required for each task is determined. An optimal route is also determined for each technician, where the optimal route includes information assigning each technician a subset of the set of tasks and a sequence each task in the subset is to be performed. The technicians' work is monitored, in that information related to a status of a portion of tasks within the sequence is received over a network from at least one device at the location, where the status corresponds to completion of subtasks of each task in the portion by each assigned technician along the determined route. This status information is analyzed and a progress along the optimal route is determined. When the determined progress is time-aligned to the determined optimal route, the optimal route is maintained and each subsequent task in the sequence is continually monitored for updated status information. When the determined progress corresponds to a different time schedule than the determined optimal route, the optimal route is updated based on the received status information and communicated to each technician.

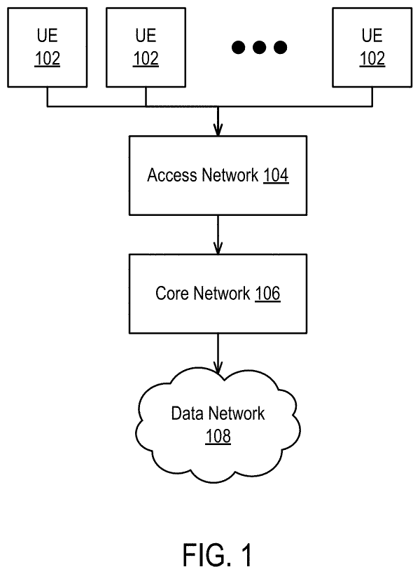

FIG. 1 is a block diagram of a network architecture for dynamically compiling, updating and leveraging a task management queue according to some embodiments of the present disclosure.

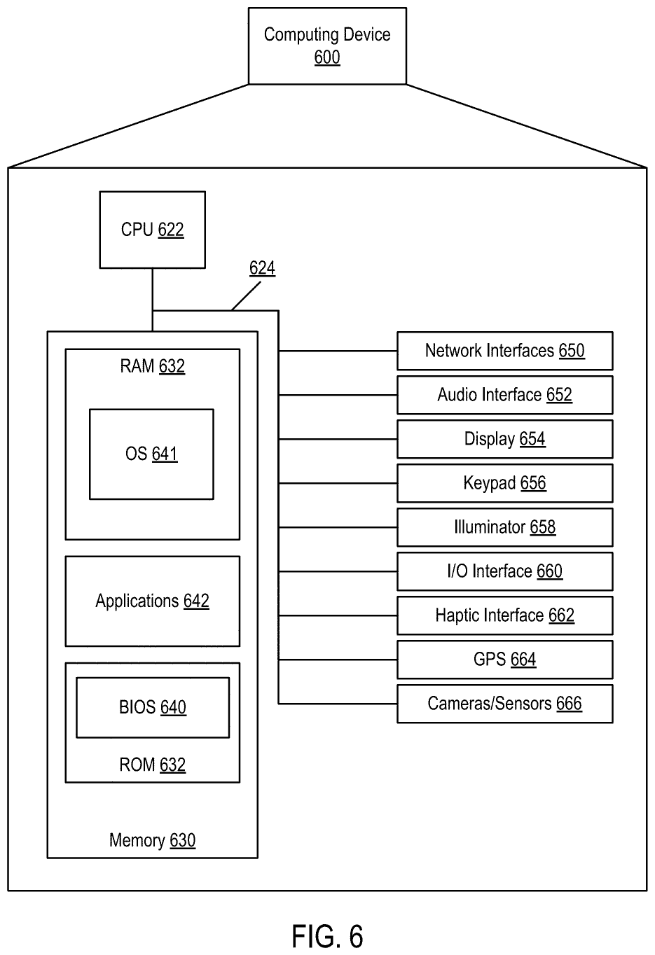

In the illustrated embodiment, user equipment (UE) 102 accesses a data network 108 via an access network 104 and a core network 106. In the illustrated embodiment, UE 102 comprises any computing device capable of communicating with the access network 104. As examples, UE 102 may include mobile phones, tablets, laptops, sensors, Internet of Things (IoT) devices, autonomous machines, and any other devices equipped with a cellular or wireless or wired transceiver. One example of a UE is provided in FIG. 6.

In the illustrated embodiment, the access network 104 comprises a network allowing over-the-air network communication with UE 102. In general, the access network 104 includes at least one base station that is communicatively coupled to the core network 106 and wirelessly coupled to zero or more UE 102.

In some embodiments, the access network 104 comprises a cellular access network, for example, a fifth-generation (5G) network or a fourth-generation (4G) network. In one embodiment, the access network 104 and UE 102 comprise a NextGen Radio Access Network (NG-RAN). In an embodiment, the access network 104 includes a plurality of next Generation Node B (gNodeB) base stations connected to UE 102 via an air interface. In one embodiment, the air interface comprises a New Radio (NR) air interface. For example, in a 5G network, individual user devices can be communicatively coupled via an X2 interface.

In the illustrated embodiment, the access network 104 provides access to a core network 106 to the UE 102. In the illustrated embodiment, the core network may be owned and/or operated by a mobile network operator (MNO) and provides wireless connectivity to UE 102. In the illustrated embodiment, this connectivity may comprise voice and data services.

At a high-level, the core network 106 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 106 and to external network-attached elements in a data network 108 such as the Internet.

In the illustrated embodiment, the access network 104 and the core network 106 are operated by an MNO. However, in some embodiments, the networks (104, 106) may be operated by a private entity and may be closed to public traffic. For example, the components of the network 106 may be provided as a single device, and the access network 104 may comprise a small form-factor base station. In these embodiments, the operator of the device can simulate a cellular network, and UE 102 can connect to this network similar to connecting to a national or regional network.

In some embodiments, the access network 104, core network 106 and data network 108 can be configured as a multi-access edge computing (MEC) network, where MEC or edge nodes are embodied as each UE 102, and are situated at the edge of a cellular network, for example, in a cellular base station or equivalent location. In general, the MEC or edge nodes may comprise UEs that comprise any computing device capable of responding to network requests from another UE 102 (referred to generally as a client) and is not intended to be limited to a specific hardware or software configuration a device.

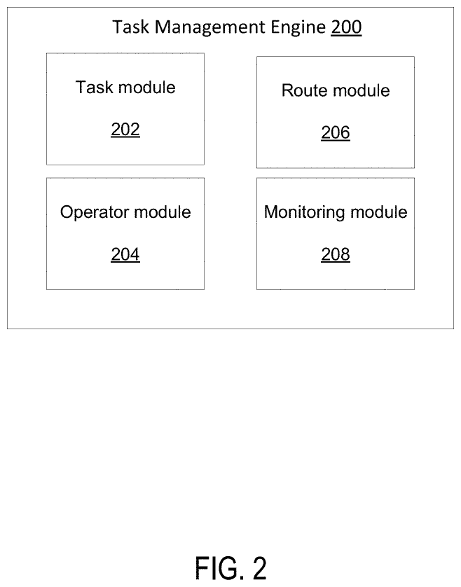

FIG. 2 is a block diagram illustrating the components for performing the systems and methods discussed herein. FIG. 2 includes task management engine 200. The task management engine 200 can be a special purpose machine or processor, and could be hosted by a cloud server (e.g., cloud web services server(s)), edge node or server, messaging server, application server, content server, social networking server, web server, search server, content provider, third party server, user's computing device, and the like, or any combination thereof. Engine 200 can be hosted within networks 104, 106 and/or 108, or some combinations thereof.

According to some embodiments, task management engine 200 can be embodied as a stand-alone application that executes on a user device. In some embodiments, the task management engine 200 can function as an application installed on the user's device, and in some embodiments, such application can be a web-based application accessed by the user device over a network. In some embodiments, the task management engine 200 can be installed as an augmenting script, program or application (e.g., a plug-in or extension) to another application.

The principal processor, server, or combination of devices that comprise hardware programmed in accordance with the special purpose functions herein is referred to for convenience as task management engine 200, and includes task module 202, operator module 204, route module 206 and monitoring module 208. The functionality and implementation of each of these modules will be discussed in detail below with reference to FIGS. 3-5K.

It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

Turning to FIG. 3, Process 300 details non-limiting example embodiments of the computerized compilation and dynamic updating process for generating an optimal task planning sequence for a set of tasks, and continuously, in at least near real-time, updating the sequence to ensure that its operatives are safe, and efficiently addressing and completing each task.

According to some embodiments, Step 302 of Process 300 is performed by task module 202 of task management engine 200; Step 304 is performed by operator module 204; Steps 306-308 and 314-316 are performed by route module 206; and Steps 310-312 are performed by monitoring module 208.

Process 300 begins with Step 302 where a set of tasks are identified. The tasks can be any type of action, activity or operation performed at a location(s). And, each task can be preset, or dynamically determined based on the operations performed at the location(s). For example, a task can be performing maintenance on a piece of machinery at a jobsite. In another example, a task can involve updating computer software on a node or hub within the location, or setting up network wiring for the location. In yet another example, a task can involve welding, plumbing, carpentry, or any other type of labor performed by a qualified technician.

In some embodiments, the location can be a jobsite, a predefined geographical area, an industrial site, a building, and the like, or any other type of geographic area that can be predefined and has a set of tasks associated therewith.

In some embodiments, each task identified in Step 302 is defined by an initial state, a final state and a sequence of sub-tasks (referred to as state transitions, interchangeably) that can be verified as they are completed. For example, the definition of a task k is as follows: {Initial state sₖ₀; List of subtasks stₖⱼ, where j from 1 to Nₛₜₖⱼ is the j-th number of required subtasks in task k; Final state s_{ld}}.

Each subtask stₖⱼ can be defined by a set of automatically verifiable actions performed by an entity that may be required to occur for the subtask to be considered complete, and a set of actions that must not happen because, for example, they impede task completion or generate safety issues.

According to some embodiments, the verifiable actions can include, but are not limited to, human-person interactions, human-device interactions, human-machine interactions, device-machine interactions, and/or agent-device interactions, and the like, or some combination thereof. Thus, for example, if a subtask is for a piece of cargo to be loaded onto a truck, a drone can be positioned to hover over the operation to monitor whether a remotely operated lift completes the subtask before continuing the operation. In some embodiments, verification can further involve a ground mounted camera capturing imagery of 1) the cargo lifting process and/or 2) whether the drone is positioned to properly capture the process.

A subtask stₖⱼ is defined as including the following information:
a) A list of verifiable positive actions P_{[stkj]i}, where i from 1 to N_{P[stkj]} is the i-th required positive action for subtask completion. In some embodiments, each action may have associated identities of technicians who can complete the action, which can be verified by, for example, a face recognition algorithm/Identity verification algorithm running in the cloud or on MEC.
b) A list of verifiable negative actions N_{[stkj]m}, where m from 1 to N_{P[stkj]} is the m-th required negative action for subtask completion. In some embodiments, a message to the planning system may be issued to warn relevant technicians that an unexpected or dangerous action is under way.
c) In some embodiments, the Global Positioning System (GPS) coordinates of the subtask and its expected completion time, obtained from expert evaluation, historical data, mean/average or some other form of numerical regression can be included as part of a subtask's definition.

Process 300 proceeds to Step 304 where a set of technicians are identified. The type (e.g., specialty) and/or quantity of technicians can be determined based on the set of tasks identified in Step 302.

For example, if the set of tasks includes fixing a crack in a pipe, updating software on a node and fixing two sewer lines, the technicians required to be identified can be as follows: a welder, software engineer and two plumbers.

According to some embodiments, the determination of the type and/or quantity of technicians can be based on analysis of the definitions of the tasks/subtasks identified in Step 302. In some embodiments, such analysis can involve executing any known or to be known analysis technique, algorithm, classifier or mechanism, including, but not limited to, computer vision, Bayesian network analysis, Hidden Markov Models, artificial neural network analysis, logical model and/or tree analysis, and the like.

In some embodiments, the determination of technicians performed in Step 304 can be included as a task/subtask definition, as discussed above in relation to Step 302. Thus, determination of the technicians can be performed by parsing the task/subtask definitions and extracting the data that indicates a type of work, which can be utilized as a query for identification of types and quantities of technicians.

In Step 306, the set of tasks (from Step 302) are analyzed, and based on this analysis, in Step 308, a determination is made regarding an optimal route for each technician. The analysis in Step 306 involves analyzing each task, determining its current status or progress, then using this data as input within an auto-regressive model, such as, for example, auto-regressive moving average model (ARMAX), auto-regressive integrated moving average model (ARIMA), auto-regressive moving average model (ARMA), and the like, as well as, for example, A* search algorithms, recurrent neural networks, linear auto-regression, and the like.

In some embodiments, the analysis of the tasks and determination of the optimal route can be further based on the technicians involved, and their availability, qualifications, positioning and the time each technician will need/require to complete each task, or some combination thereof.

In some embodiments, the analysis and determination of Steps 306-308 may also be performed using any type of analysis technique, as discussed above in relation to Step 304.

Thus, the determination of the optimal route in Step 308 produces a task specification route that sets the order for each task to be completed, and forecasts how much time each task will need before a next task can be attended to. The route (or routine, used interchangeably) is a time- and geographic-domain based sequence that can be dynamically altered or modified, automatically, based on the length of each task's completion as well as each tasks' geographical position to other tasks and other technicians.

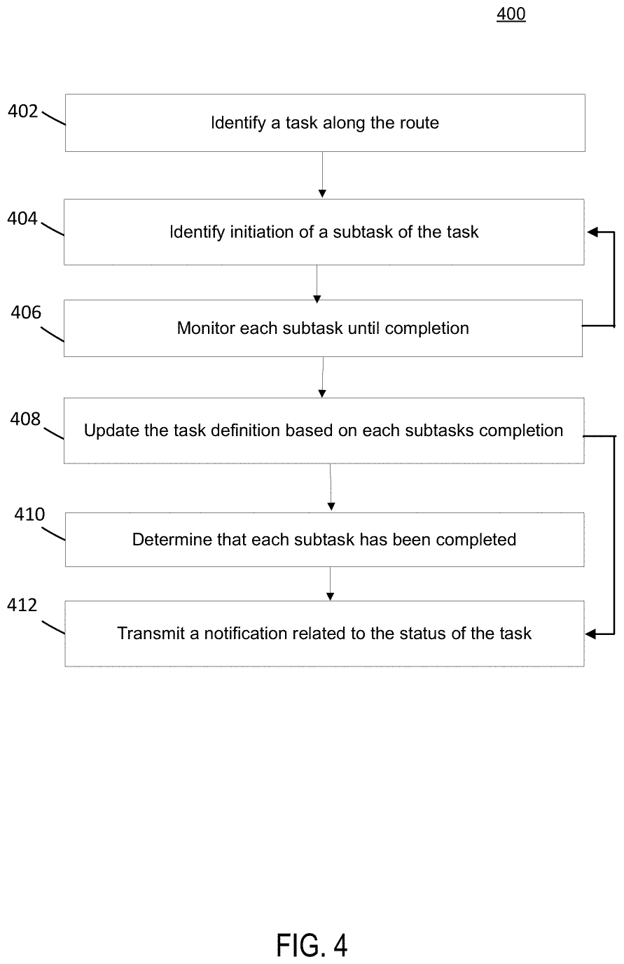

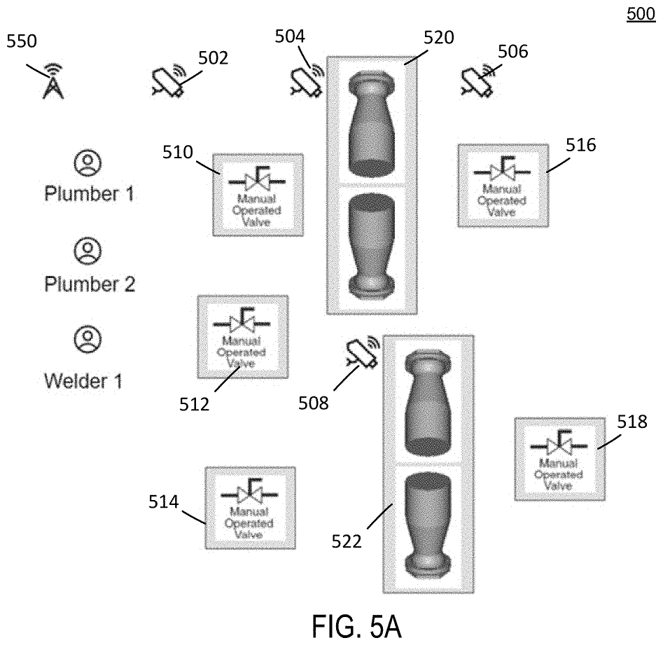

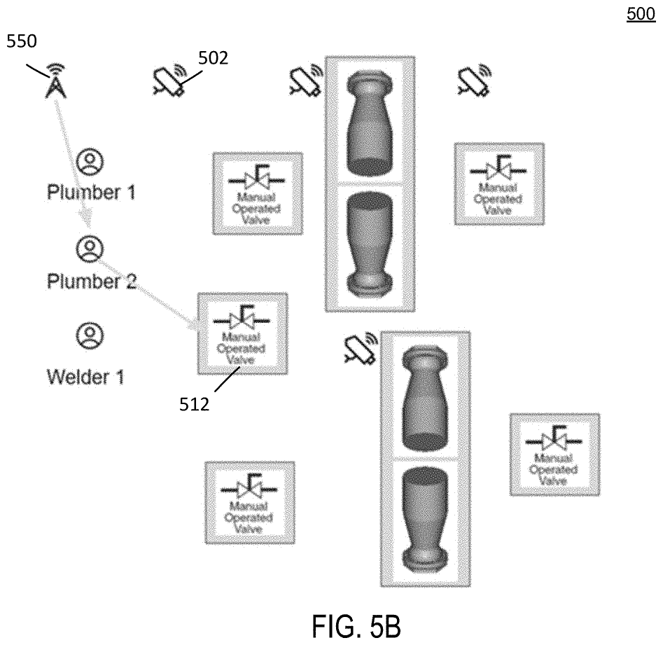

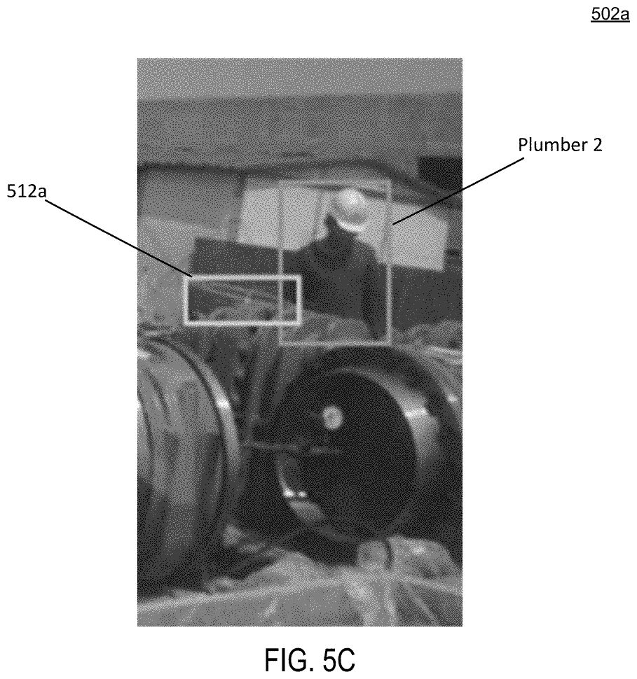

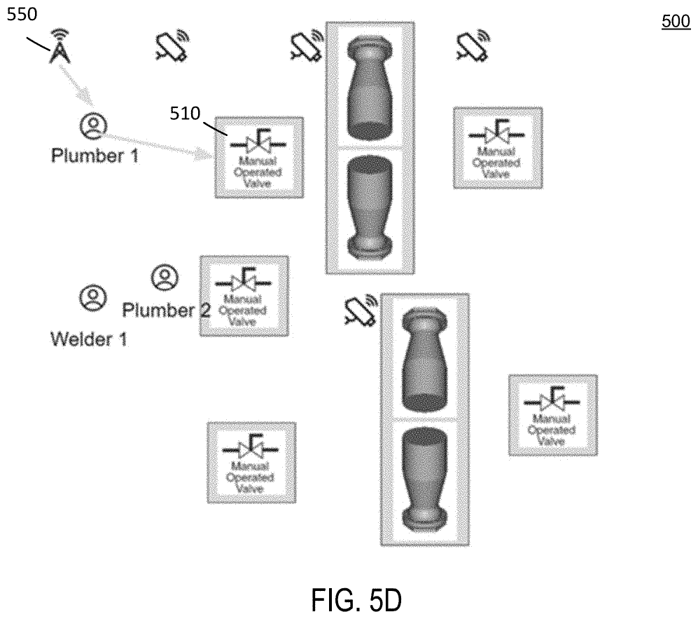

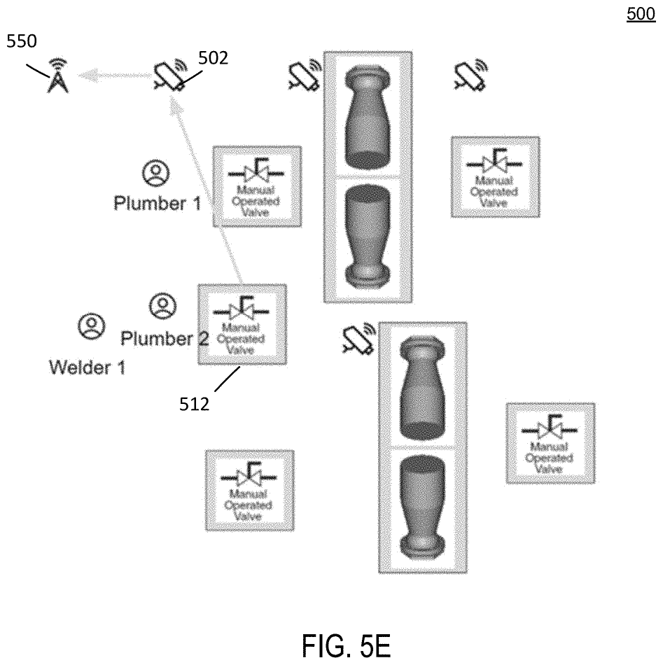

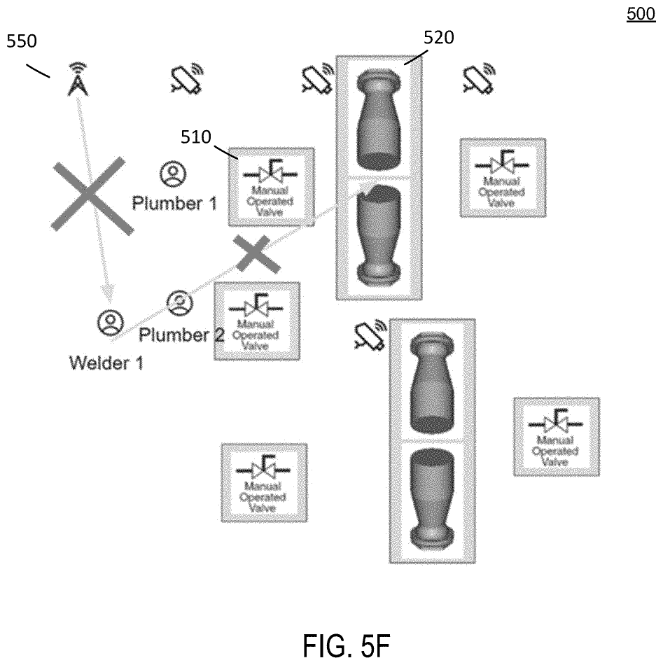

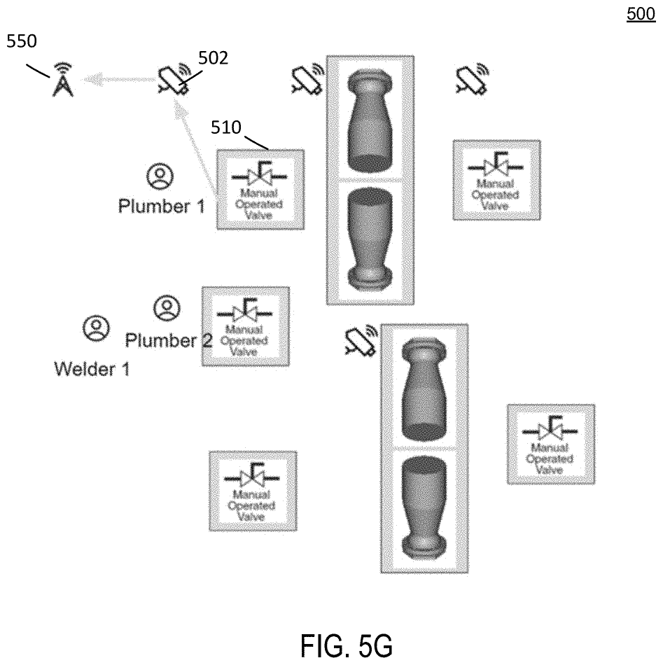

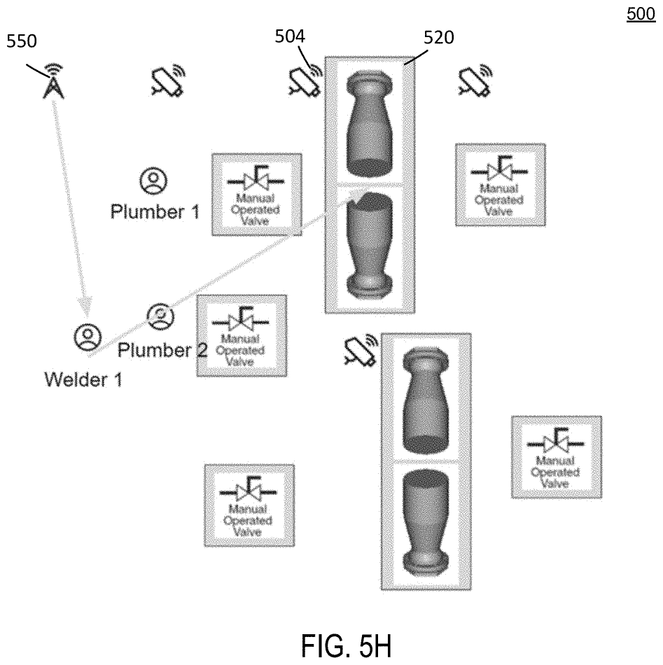

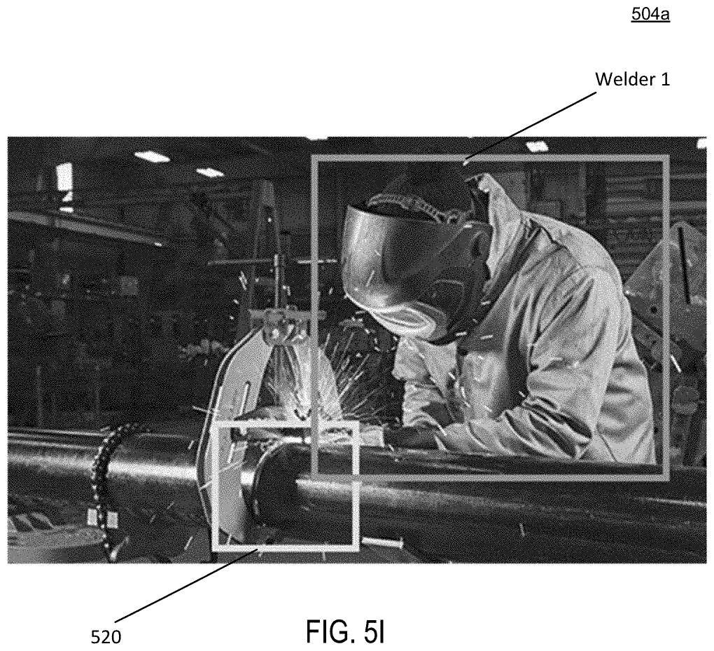

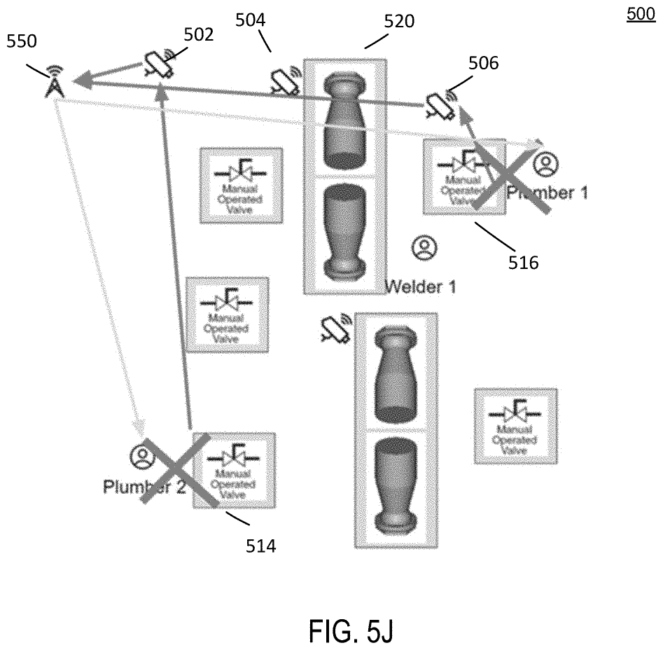

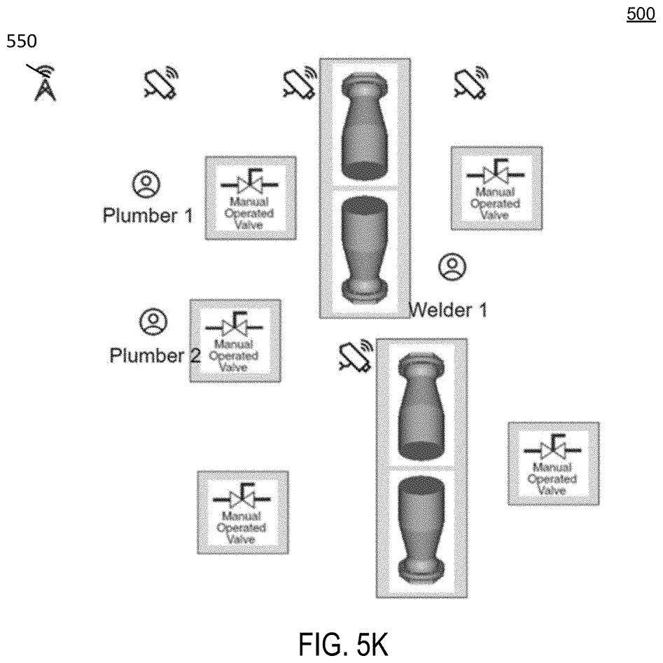

According to some embodiments, the task specification for the route contains a series of states that need to be observed (e.g., confirmed to completion) before a next task can be completed, and/or before the route can be viewed as completed. The observation of these tasks and the determination/confirmation that they are completed is discussed in more detail below in relation to FIGS. 4-5K.

In Step 310, the progress or performance of each task along the route is monitored. As a part of such monitoring, data related to each task's completion and/or current status is received. Step 312. The details of how a task is monitored and how its progress is determined and communicated to engine 200 is discussed below in relation to FIGS. 4-5K.

In some embodiments, such monitoring is performed by periodically or continuously requesting and/or receiving data related to a tasks' current status. In some embodiments, devices associated with a task (e.g., a camera situated at or near the task's location) can be configured to transmit information indicating a task's current status. For example, a camera situated at or near a task's location can capture image frames which can be analyzed to determine a task's progress, as discussed below. In another example, a technician's device can transmit GPS, gyroscope or accelerometer data than can be used to determine the technicians position and/or movements to determine a task's completion.

Such transmission can be automatic according to predetermined criteria (e.g., when a task is 50% complete send an update, when a subtask is complete, and the like), and can be specifically requested and/or can be triggered by a technician or supervisor of the location.

In some embodiments, reception of a task data may be based on a task being identified as being completed. Thus, when a task is completed, engine 200 can receive this information, and then can ping the location to determine a status of the other tasks. As discussed below, this enables a dynamically updatable route based on current progress and conditions associated with each task.

In some embodiments, engine 200 can receive a notification when a task is complete so that a technicians' next assigned task can be communicated to his/her device.

In Step 314, upon reception of task data, the data is analyzed and a progress along the route is determined. The progress provides an indication as to whether the route is being completed according to the time-domain forecasted from the initial or previous route determination (Step 308). The received task data is used to update the initial (or previously defined) task definitions, as discussed above in relation to Step 302.

In some embodiments, the analysis can involve determining whether a task is complete and/or its current progress. In some embodiments, the analysis can involve determining whether the initial (or previous route planned (from Step 308) is still the most optimal plan. This determination can be based on a comparison of the initial task definitions included in the planned route to the received task data.

When there is a threshold satisfying time differentiation between the planned route and the current data, then Process 300 proceeds to Step 316 where the optimal route can be updated for each technician based on the currently received data. Step 316. From there, monitoring is continued as Process 300 recursively proceeds back to Step 310 for continued monitoring. For example, if a task is supposed to have been completed to stay on schedule, but has not yet been completed, then Process 300 proceeds to Step 316 to update the route for that technician (upon completion of the current task) and for other technicians.

According to some embodiments, the analysis and updating performed in Steps 314-316 are performed in a similar manner to the analysis discussed above in relation to Steps 306-308 (e.g., input within an auto-regressive model).

When the tasks are determined to be performed “on schedule” according to the previously planned route, Process 300 recursively proceeds from Step 314 back to Step 310 for continued monitoring.

In some embodiments, upon the reception of data related to a task (from Step 314) and analysis thereof (Step 316), engine 200 can generate an alarm, as discussed in more detail below. Such alarm can be location-wide and received and/or sent to each technician's device, or can be technician specific, as it can alert a technician to halt work, avoid an area or to be re-routed.

Turning to FIG. 4, Process 400 details an exemplary data flow for monitoring tasks in connection with the data flow of FIG. 3 according to some embodiments of the present disclosure. The steps performed in Process 400 are sub-steps of Steps 310-312, where a task's performance is being monitored and its data is being generated and/or identified, and analyzed so that it can be fed to engine 200 for determination of a dynamic update to the initial or previously planned route.

Process 400 is performed for each technician, as each technician is performing an assigned task. For purposes of this disclosure, Process 400 will focus on a single task; however, it should not be limiting as engine 200 can monitor and analyze data for any number of tasks, whether performed sequentially, simultaneously, or some combination thereof.

Process 400 begins with Step 402 where a task along the route is identified. As discussed above, the task has an assigned technician that is to perform a set of subtasks prior to the task being considered/observed as completed.

In Step 404, initiation of the task is identified. In some embodiments, the identification of the initiation can be based on the arrival of an assigned technician to within an area proximate the location/position of the task. In some embodiments, the identification of the initiation can be based on the assigned technician beginning work—e.g., beginning a first assigned subtask.

In Step 406, the work performed by the technician is monitored. The work corresponds to the actions or activities performed by the technician in relation to the task and its subtasks. The work is determined based on data collected by at least one device at the location.

For example, as discussed above and in more detail below in relation to the examples discussed for FIGS. 5A-5K, a camera or cameras can be situated at or near the task's location so that the technician's actions respective to a task and its subtasks can be monitored and evaluated. As discussed below, the hand positioning, body pose/positioning, movements, facial expressions, attention to specific parts of equipment or machinery, and the like, can be analyzed and output as task data for a technician. This task data, therefore, indicates which subtask a technician is performing, and whether it is completed and/or being performed properly.

In some embodiments, each subtask contains one or more verifiable states (presence or absence) and optionally undesirable simultaneous states (e.g., presence of people in an area during a dangerous operation). As a simple example, consider the task of changing a light bulb being verified by a single camera in a room. It requires the following verifiable subtasks:
a) Initial state: zero people detected inside room, lights off (performed via object detection of captured images by the camera);
b) Person—light switch interaction (as a proxy to making sure lights are off);
c) Person—light bulb interaction (proxy to replacing bulb) for at least 30 s+undesirable state: detection of more than 1 person in room (triggers an alarm for safety personnel—dangerous event);
d) Person—light switch interaction (as a proxy to turning lights back on);
e) Final state: zero people detected inside room, lights on (via object detection).

Thus, Step 406 can involve collecting image data from at least one camera device, analyzing the camera data, and determining a status of a technician's work in association with a task or set of associated subtasks. The analysis performing during engine 200's monitoring can be performed any known or to be known image analysis technique, algorithm or classifier, including, but not limited to, computer vision, image analysis, attention mapping (e.g., OpenCV and eye detection algorithms), object detection, Bayesian network analysis, Hidden Markov Models, artificial neural network analysis, and the like.

Upon the determination of the completion of a subtask (from Step 406's monitoring), the task definition is updated to indicate that a subtask is completed (Step 408), and a next subtask is identified (Process 400 proceeds recursively back to Step 404).

When all of the subtasks are determined to be completed (Step 406), and each subtask within the task definition is modified to indicate that it has been completed (Step 408), it is determined that the task has been completed. Step 410. This can be determined from the task definition reaching the “final state”. Thus, in Step 412 a notification is sent that indicates the task is completed. This notification can include the task data received in Step 312 of FIG. 3.

In some embodiments, upon the completion of a subtask, and/or the updating of a task definition (even though the entire task is not completed), as determined from Step 406, a current progress/status of the task and its subtasks (e.g., those subtasks that have been completed and/or are pending completion or initiation) can be transmitted to engine 200. This transmission (as an embodiment of Step 412) can include the task data received in Step 312 of FIG. 3.

FIGS. 5A-5K illustrate a non-limiting example embodiment of the execution of Processes 300 and 400 of FIGS. 3 and 4, respectively. FIGS. 5A-5K provide an example of how data collected from cameras at a location (e.g., a jobsite) can be used to dynamically coordinate technician's actions at or within the location respective to particular equipment and each other.

The example discussed herein, which is for explanation purposes only, as illustrated in FIG. 5A, involves a location 500, connected with network 550 (e.g., MEC), with 4 cameras (502, 504, 506, 508), 5 manually operated valves (510, 512, 514, 516, 518) and 2 pipe sets (520, 522). In the example, there are three technicians: 2 plumbers and 1 welder. The tasks involve: 2 pipe sets (520, 522) to be welded by the welder (welder 1); and 5 valves (510, 512, 514, 516, 518) to be inspected by one of the plumbers (plumber 1; plumber 2).

The welding task is defined by:
a) Initial state (per pipe set): not welded;
b) Subtask: welder close to welding joint (interpretation: welding is taking place), NO plumber close to valve (if valve is being inspected, welding cannot take place because of danger);
c) Subtask: welder not close to welding joint;
d) Final state: welded.

The valve inspection task is defined by:
a) Initial state (per valve): not inspected;
b) Subtask: plumber close to valve (interpretation: inspection is taking place);
c) Subtask: plumber not close to valve;
d) Final state: inspected.

Based on the analysis of the tasks and the technicians, as discussed above in relation to Process 300, Plumbers 1 and 2 get assigned to the valve that are closest in physical proximity to them. As illustrated in FIG. 5B, plumber 2 is assigned to valve 512; and as illustrated in FIG. 5D, plumber 1 is assigned to valve 510. As illustrated in each figure, the assignment is received over network 550 (from engine 200), as discussed above.

As discussed above in relation to Process 400, each plumber's actions will be monitored and captured on a camera. For example, as depicted in FIG. 5B, plumber 2 is seen on camera 502, which captures example imagery 502a depicted in FIG. 5C. Imagery 502a illustrates that plumber 2 is interacting with valve handle 512a. As discussed above, this can be determined by capturing the image, analyzing it and determining which action the plumber is doing. For example, as discussed above, the imagery 502a (e.g., the frames captured by camera 502) can be subject to image detection analysis, object detection analysis, from which a task/subtask progress can be determined. Here, that plumber 2 is operating valve handle 512a is determined via object detection performed on imagery 502a.

As such, according to some embodiments, object detection enables engine 200 to identify which specific components of equipment have been interacted with—for example, which handle 512a of valve 512 plumber 2 interacted with. Thus, as illustrated in FIG. 5C, camera 502 is capable of identifying person-valve interactions by means of overlapping bounding boxes (512a, plumber 2, as depicted in FIG. 5C) for the required inspection time (e.g., assuming for a threshold period of time, for example, 30 seconds).

Thus, here, plumber 2's task of “valve inspection” can be defined by:
a) Initial state: detect valve 512's handle 512a using camera 502, and set valve state to “not inspected”;
b) When plumber 2 interacts with valve 512a for longer than 30 s: set valve 512a state to “inspected”
c) Final state: valve 512 state is “inspected”

It should be understood that the above example can be expanded to work for a plurality of subtasks—e.g., more than one valve, more than one handle, and/or more than one plumber performing the subtasks (e.g., set all valve handles V(i) by P(i) via C(i)—where V(i) represents a plurality of valves; P(i) represents a plurality of plumbers; and C(i) represents a plurality of cameras).

FIG. 5E depicts actions of plumber 2 at valve 512 being captured by camera 502, and sent over network 550 to engine 200, as discussed above. This signal, can be viewed as the status transmission from Step 412, indicates that plumber 2's interaction with the valve 512a (which is a subtask) has been completed.

As illustrated in FIG. 5F, since plumber 1 is still working on valve 510, welder 1 cannot be sent to weld pipe set 520. This would generate a conflict that arises, for example, from safety measures of a welding operation being performed near an open valve.

In FIG. 5G, in a similar manner as discussed above in relation to FIGS. 5C and 5E, it is determined that plumber 1 has finished a task or subtask associated with valve 510, therefore, this data is captured by camera 502 and is sent over network 550 to engine 200. For example, the camera 502 may no longer capture plumber 1's presence within captured frames (image detection analysis), therefore, it can be determined that plumber 1 has completed the task associated with valve 510.

Thus, since plumber 1 is determined to have completed his task for valve 510, welder 1 can be sent to pipe set 520. This is depicted in FIG. 5H.

From FIG. 5H, imagery 504a from camera 504 captures welder 1 working on pipe set 520. This is illustrated in FIG. 5I.

As discussed above, for example, welder 1 can be determined to be working on the pipe set 520 based on object detection and/or attention scoring. For example, as illustrated in FIG. 5I, the pipe set 520 is seen being interacted with by welder 1—this is an example of the object detection discussed above.

In another example embodiment, welder 1 is determined to be focusing his/her attention on a joint of the pipe set 520 using a welding tool—this an example of the attention mapping discussed above. In some embodiments, such attention can be determined based on attention scoring, where when it is determined that welder 1 (technician) interacts with an asset/tool (e.g., the pipe set 520) for a period of time longer than a threshold period of time (e.g., 30 seconds), then it can be determined that the sub task is being completed. Thus, imagery 504a can include a threshold satisfying set of frames that are analyzed in order to ensure the threshold period of time is capable of being satisfied.

In FIG. 5J, an example is illustrated where an alarm is generated because a set of tasks are being performed in proximity of each other that causes a dangerous situation to the jobsite 500 as well as the operating technicians. For example, while welder 1 is seen interacting with pipe set 520, plumber 1 is working on valve 516, and plumber 2 is seen working on valve 514. In this example, cameras 504 and 506 operate together, as their data is compiled in order to detect a co-occurrence of technicians operating at the same location but at different positions therein. The object detection and task/subtask determination performed from the captured camera imagery of cameras 504 and 506 enables engine 200 to receive the data over network 550, from which a determination can be made that the plumbing tasks/subtasks should not be performed while the welding task/subtasks are being performed. Thus, engine 200 can generate an alarm, which can be transmitted to each plumber's device—as indicated by the “X” overlaid each technician-asset combination (e.g., plumber 1, 516; plumber 2, 514). The alarm can inform them they need to stop, move and/or evacuate the site, or that another task/subtask is being provided to them due to welder 1 being at pipe set 520.

In FIG. 5K, an example is illustrated that all the tasks and their associated subtasks are completed by the assigned technicians. This is depicted by the bolded/thick lines outlining the mapping of each asset/equipment at the location 500. As discussed above in relation to Processes 300 and 400, upon such completion, engine 200 recognizes that all planned tasks are completed and the technicians are informed of the same.

According to some embodiments, the operation of Processes 300 and 400 can function for operations on a single piece of equipment as well, rather than only on separate equipment at a location. The route planning is the same as discussed above, yet the subtasks can be split between technicians. Before a second technician can work on a second part of the equipment, a first technician must complete the preceding subtask.

For example, the following operation must be performed:
1) Pipe alignment and geometric fitting (by plumber);
2) Welding (by welder); and
3) Cleaning of welded pipe set (by plumber).

The following indicates the sequential steps of the operation of building a pipe set by a welder(s) and plumber(s):
a) Initial state: pipes separated—weld not ready
b) Op1 interacts with 2 pipes to be welded together (hands, body pose detected by captured camera data analysis)
c) Two Op2's interact with the pipe (simultaneous weld is a requirement to avoid unacceptable levels of deformation)
d) At least one Op3 interacts with the pipe to clean the weld
e) Final state: weld ready and clean

Where OpN as the operator that performs operation N.

The steps described above may also include other requirements, such as, but not limited to, a maximum number of people in the scene which are not operators (safety requirement), a minimum duration of each operation, no interaction with cell phone—distraction and the like. These would be identifiable with time measurements or by object detection performed by engine 200, as discussed above.

FIG. 6 is a block diagram illustrating a computing device showing an example of a client or server device used in the various embodiments of the disclosure.

The computing device 600 may include more or fewer components than those shown in FIG. 6, depending on the deployment or usage of the device 600. For example, a server computing device, such as a rack-mounted server, may not include audio interfaces 652, displays 654, keypads 656, illuminators 658, haptic interfaces 662, GPS receivers 664, or cameras/sensors 666. Some devices may include additional components not shown, such as graphics processing unit (GPU) devices, cryptographic co-processors, artificial intelligence (AI) accelerators, or other peripheral devices.

As shown in FIG. 6, the device 600 includes a central processing unit (CPU) 622 in communication with a mass memory 630 via a bus 624. The computing device 600 also includes one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal, or electromagnetic sensors 666. Device 600 can include one camera/sensor 666 or a plurality of cameras/sensors 666. The positioning of the camera(s)/sensor(s) 666 on the device 600 can change per device 600 model, per device 600 capabilities, and the like, or some combination thereof.

In some embodiments, the CPU 622 may comprise a general-purpose CPU. The CPU 622 may comprise a single-core or multiple-core CPU. The CPU 622 may comprise a system-on-a-chip (SoC) or a similar embedded system. In some embodiments, a GPU may be used in place of, or in combination with, a CPU 622. Mass memory 630 may comprise a dynamic random-access memory (DRAM) device, a static random-access memory device (SRAM), or a Flash (e.g., NAND Flash) memory device. In some embodiments, mass memory 630 may comprise a combination of such memory types. In one embodiment, the bus 624 may comprise a Peripheral Component Interconnect Express (PCIe) bus. In some embodiments, the bus 624 may comprise multiple busses instead of a single bus.

Mass memory 630 illustrates another example of computer storage media for the storage of information such as computer-readable instructions, data structures, program modules, or other data. Mass memory 630 stores a basic input/output system (“BIOS”) 640 for controlling the low-level operation of the computing device 600. The mass memory also stores an operating system 641 for controlling the operation of the computing device 600.

Applications 642 may include computer-executable instructions which, when executed by the computing device 600, perform any of the methods (or portions of the methods) described previously in the description of the preceding Figures. In some embodiments, the software or programs implementing the method embodiments can be read from a hard disk drive (not illustrated) and temporarily stored in RAM 632 by CPU 622. CPU 622 may then read the software or data from RAM 632, process them, and store them to RAM 632 again.

The computing device 600 may optionally communicate with a base station (not shown) or directly with another computing device. Network interface 650 is sometimes known as a transceiver, transceiving device, or network interface card (NIC).

The audio interface 652 produces and receives audio signals such as the sound of a human voice. For example, the audio interface 652 may be coupled to a speaker and microphone (not shown) to enable telecommunication with others or generate an audio acknowledgment for some action. Display 654 may be a liquid crystal display (LCD), gas plasma, light-emitting diode (LED), or any other type of display used with a computing device. Display 654 may also include a touch-sensitive screen arranged to receive input from an object such as a stylus or a digit from a human hand.

Keypad 656 may comprise any input device arranged to receive input from a user. Illuminator 658 may provide a status indication or provide light.

The computing device 600 also comprises an input/output interface 660 for communicating with external devices, using communication technologies, such as USB, infrared, Bluetooth™, or the like. The haptic interface 662 provides tactile feedback to a user of the client device.

The optional GPS transceiver 664 can determine the physical coordinates of the computing device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS, or the like, to further determine the physical location of the computing device 600 on the surface of the Earth. In one embodiment, however, the computing device 600 may communicate through other components, provide other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
identifying, by a computing device, a set of tasks, each task corresponding to an action to be performed on an asset by an entity at a location, each task comprising a definition identifying a set of subtasks;
analyzing, by the computing device, the task definitions for each task, and determining a quantity and type of entity required for performing the actions of each task;
further determining, based on the analysis, an optimal route for each entity, the optimal route comprising information assigning each entity a subset of the set of tasks and a sequence each task in the subset is to be performed;
receiving, by the computing device, over a network from at least one device at the location, information related to a status of a portion of tasks within the sequence, the status corresponding to performance of subtasks of each task in the portion by each assigned entity along the determined route;
analyzing, by the computing device, the received status information, and based on the analysis, determining a progress along the optimal route,
when the determined progress is time-aligned to the determined optimal route, the optimal route is maintained and each subsequent task in the sequence is continually monitored for updated status information, and
when the determined progress corresponds to a different time parameter than the determined optimal route, modifying the optimal route so that it is updated based on the received status information, and electronically communicating information related to the updated optimal route to a device of each entity.

2. The method of claim 1, wherein the updated route comprises a new sequence of the tasks.

3. The method of claim 1, wherein the updated route comprises a different set of assigned tasks for at least a portion of the entities.

4. The method of claim 1, wherein reception and analysis of the status information step is recursively performed until each of the set of tasks are completed, wherein a task is determined to be completed when each of its subtasks are completed.

5. The method of claim 1, wherein the status information for a task is communicated over the network upon detection that a subtask has been completed.

6. The method of claim 1, wherein the task definition for each task in the subset is updated based on the received status information.

7. The method of claim 1, wherein the at least one device is a camera, wherein the camera is positioned proximate to at least a portion of assets at the location.

8. The method of claim 7, further comprising:
receiving, over the network from the at least one camera, a set of digital images related to performance of a subtask of a task in the subset; and
analyzing the set of digital images, and based on the analysis, determining a status of the subtask, wherein the received status information corresponds to the determined status.

9. The method of claim 8, wherein the analysis comprises execution of an attention mapping algorithm on input defined by the set of digital images, wherein the determined status is based on a determination of which component of an asset an entity is interacting with.

10. The method of claim 8, wherein the analysis comprises execution of an object detection algorithm on input defined by the set of digital images, wherein the determined status is based on at least a detected pose or gesture of an entity.

11. The method of claim 1, further comprising:
determining, based on the analysis of the received status information, that an alarm needs to be communicated to at least one entity at the location, the alarm indicating a safety issue that provides a corresponding instruction to the at least one entity.

12. The method of claim 1, wherein the determination of the optimal route is based on execution of an auto-regressive model with an input comprising at least the task definitions.

13. The method of claim 1, wherein the quantity of entities corresponds to a number of a type of entities that are required to perform each subtask.

14. The method of claim 1, wherein the type of entities corresponds to a qualification an entity has to perform each task.

15. The method of claim 1, wherein the location comprises a plurality of assets, wherein each asset is equipment or machinery.

16. A device comprising:
a processor configured to:
identify a set of tasks, each task corresponding to an action to be performed on an asset by an entity at a location, each task comprising a definition identifying a set of subtasks;
analyze the task definitions for each task, and determining a quantity and type of entity required for performing the actions of each task;
further determine an optimal route for each entity, the optimal route comprising information assigning each entity a subset of the set of tasks and a sequence each task in the subset is to be performed;
receive, over a network from at least one device at the location, information related to a status of a portion of tasks within the sequence, the status corresponding to performance of subtasks of each task in the portion by each assigned entity along the determined route;
analyze the received status information, and based on the analysis, determining a progress along the optimal route,
when the determined progress is time-aligned to the determined optimal route, the optimal route is maintained and each subsequent task in the sequence is continually monitored for updated status information, and
when the determined progress corresponds to a different time parameter than the determined optimal route, modify the optimal route so that it is updated based on the received status information, and electronically communicate information related to the updated optimal route to a device of each entity.

17. The device of claim 16, further comprising:
receive, over the network from the at least one device, a set of digital images related to performance of a subtask of a task in the subset; and
analyze the set of digital images, and based on the analysis, determine a status of the subtask, wherein the received status information corresponds to the determined status.

18. The device of claim 17, wherein the analysis comprises execution of an attention mapping algorithm on input defined by the set of digital images, wherein the determined status is based on a determination of which component of an asset an entity is interacting with.

19. The device of claim 17, wherein the analysis comprises execution of an object detection algorithm on input defined by the set of digital images, wherein the determined status is based on at least a detected pose or gesture of an entity.

20. A non-transitory computer-readable medium tangibly encoded with instructions, that when executed by a processor, perform a method comprising:
identifying, by a processor, a set of tasks, each task corresponding to an action to be performed on an asset by an entity at a location, each task comprising a definition identifying a set of subtasks;
analyzing, by the processor, the task definitions for each task, and determining a quantity and type of entity required for performing the actions of each task;
further determining, based on the analysis, an optimal route for each entity, the optimal route comprising information assigning each entity a subset of the set of tasks and a sequence each task in the subset is to be performed;
receiving, by the processor, over a network from at least one device at the location, information related to a status of a portion of tasks within the sequence, the status corresponding to performance of subtasks of each task in the portion by each assigned entity along the determined route;
analyzing, by the processor, the received status information, and based on the analysis, determining a progress along the optimal route,
when the determined progress is time-aligned to the determined optimal route, the optimal route is maintained and each subsequent task in the sequence is continually monitored for updated status information, and
when the determined progress corresponds to a different time parameter than the determined optimal route, modifying the optimal route so that it is updated based on the received status information, and electronically communicating information related to the updated optimal route to a device of each entity.
